(19) United States
(12) Patent Application Publication
(10) Pub. No.: US 2011/0029361 A1
(43) Pub. Date: Feb. 3, 2011

(54) LINEAR AUDIO ADVERTISING SYSTEM

(76) Inventor: RUDOLPH DELEON, Hollywood, CA (US)

Correspondence Address: LAW OFFICE OF JERRY D. HAYNES , P.A, P.O. Box 350392, Fort Lauderdale, FL, 33335, US

(21) Appl. No.: 12/512,201

(22) Filed: Jul. 30, 2009

(51) Int. Cl. G06Q 30/00; G06F 17/00

(52) U.S. Cl. 705/14.4; 700/94

(57) ABSTRACT

The present invention relates to an audio advertising system for a bus or train stop installation comprising: a digital audio player, where the audio player stores and plays audio files; at least one audio speaker, where said at least audio speaker broadcasts the desired audio files stored on the digital audio player; at least one advertising panel; and a solar power source, where said solar power source supplies power to the advertising system. The audio files may include messages, jingles or music. The audio files may be directed toward advertising. In one particular embodiment, the audio files promote and coincide with the advertising posted on the at least one advertising panel. The audio advertising system of the current invention enables the combination of visual advertising and audio advertising that may coincide with the advertisement of the advertising panels.

### BACKGROUND OF THE INVENTION

1. Field of Invention

The present invention relates to an advertising system implemented at a bus stop installation.

2. Description of Related Art

Outdoor benches and bus stop enclosures are usually utilized for advertising purposes in addition to serving as a bench or standing area along a bus route. A number of times the back support of the bench includes an advertising billboard or display advertising a particular product or service. In some instances, the advertising may be illuminated to provide a more visible display during the nighttime. In other cases a simple placard is utilized on the side of the bus enclosure or along the bench of the bus stop. Where the bus enclosure includes perimeter walls, the perimeter walls may include advertising and provide multiple opportunities for advertisement on each wall thereof.

U.S. Pat. No. 5,329,716 discloses an outdoor advertising bench that is utilized as an advertising medium where the seatback assembly includes an exposed face that is transparent with lights reflecting through the transparency to provide an illuminated advertising bench. Another example of bus or train stop advertisement is disclosed in U.S. Pat. No. 4,176,486. The '486 patent discloses a display frame that carries a sheet of Mylar metalized to provide a mirror and an advertising display placard with a number of strap sets able to attach to an I-Beam configuration found in a subway or a train station.

The advertising displays to the prior art are essentially limited to a placard or display that is fixed and unable to be updated or changed conveniently nor does the advertiser have the opportunity to provide further information not included on the display. It would be advantageous to actually have audio messages that may be played in conjunction with the display or as a separate form of advertising at a bus stop. The current technology definitely makes creation of such a system feasible.

### SUMMARY OF THE INVENTION

The present invention relates to an audio advertising system for a bus or train stop installation comprising: a digital audio player, where the audio player stores and plays audio files; at least one audio speaker, where said at least audio speaker broadcasts the desired audio files stored on the digital audio player; at least one advertising panel; and a solar power source, where said solar power source supplies power to the advertising system. The audio files may include messages, jingles or music. The audio files may be directed toward advertising. In one particular embodiment, the audio files promote and coincide with the advertising posted on the at least one advertising panel. The audio advertising system of the current invention enables the combination of visual advertising and audio advertising that may coincide with the advertisement of the advertising panels.

### DESCRIPTION OF DRAWINGS

FIG. 1 depicts a linear audio advertising system according to the present invention.

### DETAILED DESCRIPTION

The present invention relates to a linear audio advertising system that is utilized at a bus stop enclosure or installation. The audio advertising system according to the present invention plays audio messages on a continuous or periodic basis to provide a means of directing or supplementing advertising ads for pedestrians that may be waiting for a bus at the bus stop enclosure. In one exemplary embodiment, the present invention also includes advertising panels for visual advertisement in addition to the audio messages or jingles that may play at the bus stop enclosure.

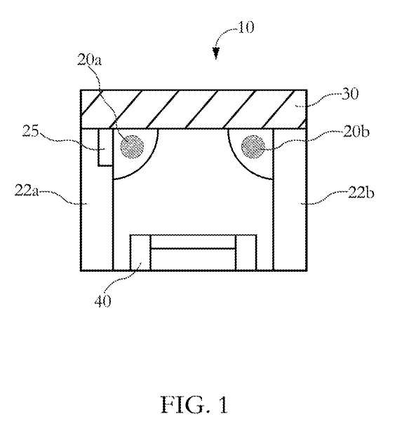

The Bus Stop Advertising System 10 depicted in FIG. 1 includes a pair of audio speakers 20a, 20b where the speakers 20a, 20b are mounted in the upper corners of the bus enclosure. The speakers 20a, 20b provide a means to broadcast audio advertising messages to the individuals that may be standing or sitting near the bus stop enclosure. Although two speakers are depicted, a single speaker or a plurality of speakers may be utilized to broadcast the messages. The bus stop enclosure includes a bench 40 and two sidewalls 22a, 22b where the sidewalls 22a and 22b are utilized as advertising panels to provide the visual advertisement for the bus stop enclosure. A bus stop enclosure further includes a solar collection panel 30 where the solar panel stores energy to power the advertising system 10 available at the bus stop. The advertising system 10 includes an MP3 Player 25 enclosed on one side of the bus stop enclosure. The MP3 Player 25 is shown as enclosed in the wall panel 22a. This particular location for the MP3 Player 25 is not mandatory and the MP3 Player 25 may be positioned within the opposite wall panel 22b or in any other suitable enclosed area within the bus stop enclosure. Furthermore, although this particular embodiment of the present invention contemplates use of a MP3 player any other digital audio player may be utilized to store and play messages, jingles, music or other audio files. The advertising system 10 therefore provides two means of advertisement and the audio advertisement may be utilized to reinforce the visual advertisement that is provided.

In one particular embodiment according to the present invention, an advertiser may position the advertisement in one or both of the wall panel displays 22a, 22b and in order to reinforce the advertisements an audio ad is played in conjunction with the wall display advertisement. Many of the popular ad campaigns include particular music or a jingle that is associated with the ad to attract the consumer and embed the product or service into the consumer's memory. The advertising system 10 provides the advertiser with a visual advertisement and an audio message explaining or further pitching the product visually advertised. Such a method of advertisement therefore may further entice or attract customers to the advertiser's products or services. An alternative embodiment of the present invention may include audio advertisement for other products not displayed in either the wall panel of the bus enclosure. Further a single advertiser may purchase the entire advertising space and audio content for the bus enclosure or the advertising may be shared between the various advertisers.

The linear audio advertising system of the present invention enhances the advertising capabilities as opposed to the prior art methods of simple posters, billboards or visual means of advertising. The installation of this system is not complex and therefore may be implemented into existing bus enclosures or developed in conjunction with newly designed bus enclosures. The audio component of the advertising system 10 enables the advertiser to capture a pedestrian's attention by playing music jingles or other messages and therefore heighten the interest of pedestrians waiting on their bus. Furthermore, the advertising system according to the present invention is powered via solar power and therefore it does not provide an additional drain on the current energy system and promotes the use of alternative energy sources such as solar power.

What is claimed is:

1. An audio advertising system for a bus or train stop installation comprising:
a. a digital audio player, where the audio player stores and plays audio files;
b. at least one audio speaker, where said at least audio speaker broadcasts the desired audio files stored on the digital audio player;
c. at least one advertising panel; and
d. a solar power source, where said solar power source supplies power to the advertising system.

2. The audio advertising system according to claim 1, where said audio files include at least one of messages, jingles and music.

3. The audio advertising system according to claim 2, where said audio files are directed toward advertising.

4. The audio advertising system according to claim 3, where said advertising within the audio files promotes and coincides with the advertising posted on the at least one advertising panel.

5. The audio advertising system according to claim 1, where said audio player is a MP3 player.

6. The audio advertising system according to claim 1, where said audio files are played continuously.

7. The audio advertising system according to claim 1, where said audio files are played periodically.

8. An audio advertising system for a bus or train stop installation comprising:
a. a digital audio player, where the audio player stores and plays a plurality of audio files;
b. two audio speakers, where said two speakers broadcast the desired audio files stored on the digital audio player;
c. a pair of advertising panels; and
d. a solar power source, where said solar power source supplies power to the advertising system.

9. The audio advertising system according to claim 8, where said plurality of audio files includes at least one of messages, jingles and music.

10. The audio advertising system according to claim 9, where said plurality of audio files is directed toward advertising.

11. The audio advertising system according to claim 10, where said advertising within the plurality of audio files promotes and coincides with the advertising posted on the pair of advertising panels.

12. The audio advertising system according to claim 6, where said audio player is a MP3 player.
